(19) United States
(12) Patent Application Publication
(10) Pub. No.: US 2025/0372852 A1
(43) Pub. Date: Dec. 4, 2025

(54) PHASE SHIFTER ASSEMBLY AND BASE STATION ANTENNA

(71) Applicant: Outdoor Wireless Networks LLC, Richardson, TX (US)

(72) Inventors: Changfu Chen, Suzhou (CN); YueMin Li, Suzhou (CN); Jian Zhang, Suzhou (CN); Bin Sun, Suzhou (CN); Cheng Xue, Suzhou (CN); Pengfei Guo, Suzhou (CN); Bingyang Li, Suzhou (CN)

(21) Appl. No.: 19/221,959

(22) Filed: May 29, 2025

(30) Foreign Application Priority Data
May 30, 2024 (CN) 2024106860471

(51) Int. Cl. H01P 1/18; H01P 3/08; H01Q 3/36

(52) U.S. Cl. CPC H01P 1/18; H01P 3/08; H01Q 3/36

(57) ABSTRACT

A phase shifter assembly comprises a first housing that has first and second cavities that are arranged side by side in the horizontal direction or the first cavity and second cavity are arranged perpendicular to each other in the forward direction. The assembly further comprises a first transmission line that is configured to feed radiating elements with an RF signal in a first polarization direction, where a first line portion of the first transmission line is mounted within the first cavity and a second line portion of the first transmission line is mounted within the second cavity.

### CROSS-REFERENCE TO RELATED APPLICATION

The present application claims priority to Chinese Patent Application No. 202410686047.1, filed May 30, 2024, the entire content of which is incorporated herein by reference as if set forth fully herein.

### FIELD

The present disclosure relates to the field of radio communications, and more specifically, to a phase shifter assembly and a base station antenna.

### BACKGROUND

Wireless base stations are well known in the art, and generally include baseband units, radio units, antennas and other components. Antennas are configured to provide bidirectional radio frequency (“RF”) communication with fixed and mobile subscribers (“users”) located throughout the cell. Generally, antennas are installed on towers or raised structures such as poles, roofs, water towers, etc., and separate baseband units and radio units are connected to the antennas.

FIG. 1 is a structural schematic diagram of a conventional base station 40. The base station 40 generally comprises a base station antenna 45 that is capable of being mounted on an antenna tower 44. The base station 40 further comprises a baseband unit 41 and a radio unit 42. In order to simplify the attached drawing, a single baseband unit 41 and a single radio unit 42 are shown in FIG. 1. However, it should be understood that more than one baseband unit 41 and/or radio unit 42 may be provided. In addition, although the radio unit 42 is shown as being located at the same position as the baseband unit 41 at the bottom of the antenna tower 44, it should be understood that in other cases, the radio unit 42 may be a remote radio head (RRH) mounted on the antenna tower 44 adjacent to the base station antenna 45. The baseband unit 41 is capable of receiving data from another source (e.g., a backhaul network [not shown]), and is capable of processing the data and providing a data stream to the radio unit 42. The radio unit 42 may generate RF signals including data encoded therein and may amplify and transmit these RF signals to the base station antenna 45 through an RF cable 43 (e.g. a coaxial transmission cable). It should also be understood that the base station 40 of FIG. 1 may generally also comprise various other devices (not shown), such as a power supply, a backup battery, a power bus, an antenna interface signal group (AISG) controller, and the like. Generally, a base station antenna includes one or a plurality of phased arrays of radiating elements, wherein the radiating elements are arranged in one or a plurality of columns when the antenna is installed for use.

In order to transmit and receive RF signals to and from the defined coverage area, the antenna beams generated by a radiating element array included in the base station antenna 45 are generally inclined at a certain downward angle with respect to the horizontal plane (referred to as a “downtilt”). In some cases, the downtilt of the antenna beam is generated electrically by adjusting the relative phase of sub-components of RF signals fed to each set of radiating elements in the array that generates the antenna beam. The amount of electric downtilt applied to antenna beams generated by the radiating element array of the base station antenna 45 is capable of, in some cases, being adjusted from a remote location. When the base station antenna 45 has such an electrical tilting capability, the physical orientation of the base station antenna 45 may remain fixed, but the effective inclination angle of a generated antenna beam (e.g., the peak of the antenna beam relative to the directional angle of the horizontal plane) may still be electrically adjustable, such as by controlling a phase shifter that adjusts the relative phase of sub-components of RF signals provided to each radiating element in the array included in the base station antenna 45. The phase shifter and other related circuits are generally built into the base station antenna 45 and are capable of being controlled from a remote location. Typically, an AISG control signal is used to control the phase shifter.

Each phase shifter may generally be constructed with a power divider as part of a feeder network (or feeder component) of the base station antenna 45 that feeds RF signals received from the radio unit 42 to the radiating element array included in the base station antenna 45. The power divider divides the RF signals input to the feeder network into a plurality of sub-components, and the phase shifter applies an adjustable phase shift to each sub-component individually so that each sub-component is fed to the corresponding sub-array comprising one or a plurality of radiating elements. Many different types of phase shifters are known in the art, including rotary wiper arm phase shifters, trombone style phase shifters, sliding dielectric phase shifters, and sliding metal phase shifters. Each of the above types of phase shifters may be implemented as a cavity phase shifter, wherein the phase shifter may be enclosed in a metal housing coupled to an electrical ground.

In many applications, achieving high antenna gain when using these types of antennas is very important. However, in a base station antenna, input cables are typically used to directly feed RF signals to the phase shifters, resulting in a large insertion loss of the antenna, which affects antenna gain. Additionally, cavity phase shifters often have deep metal cavities (more specifically higher cavities in the forward direction) which can easily lead to resonances that affect the RF performance of the antenna. Moreover, larger cavities also occupy more internal space of the antenna, which makes it more difficult to install other components.

### SUMMARY

A brief overview of the present disclosure is given below in order to provide a basic understanding of some aspects of the present disclosure. However, it should be understood that this overview is not an exhaustive overview of the present disclosure. It is not intended to be used to determine a critical or important part of the present disclosure, nor is it intended to be used to define the scope of the present disclosure. The purpose is merely to provide certain concepts of the present disclosure in simplified form as a preamble to the more detailed description provided later.

The objective of the present disclosure is to provide a phase shifter assembly and a related base station antenna capable of overcoming at least one drawback in the prior art.

According to a first aspect of the present disclosure, a phase shifter assembly is provided, wherein the phase shifter assembly comprises: a first housing comprising a first cavity and a second cavity, wherein the first cavity and second cavity are arranged side by side in the horizontal direction or the first cavity and second cavity are arranged perpendicular to each other in the forward direction; and a first transmission line configured to feed radiating elements with an RF signal in a first polarization direction, wherein a first line portion of the first transmission line is mounted within the first cavity and a second line portion of the first transmission line is mounted within the second cavity.

According to a second aspect of the present disclosure, a phase shifter assembly is also provided, wherein the phase shifter assembly comprises: a first housing comprising a first phase shifter cavity; a first transmission line mounted within the first phase shifter cavity; a second housing arranged adjacent to the first housing in the horizontal direction and detachably coupled to the first housing, wherein the second housing comprises a first feed cavity; and a first feed line mounted within the first feed cavity, wherein the first feed line is configured to feed the first transmission line.

According to a third aspect of the present disclosure, a base station antenna is provided, wherein the base station antenna comprises: the phase shifter assembly and the radiating element as described above, wherein the radiating element is arranged behind the radiating element in the forward direction.

Through the following detailed description of exemplary examples of the present disclosure by referencing the attached drawings, other features and advantages of the present disclosure will become clearer.

### BRIEF DESCRIPTION OF THE DRAWING

The foregoing and other features and advantages of the present disclosure will become clear from the following descriptions of the examples of the present disclosure shown in conjunction with the attached drawings. The attached drawings are incorporated herein and form a part of the Specification to further explain the principles of the present disclosure and enable those skilled in the art to make and use the present disclosure.

FIG. 1 shows a structural schematic diagram of a conventional base station.

FIG. 2 shows a schematic partial perspective view of a base station antenna comprising an exemplary phase shifter assembly.

FIG. 3-FIG. 4 separately show schematic partial perspective views of a base station antenna comprising a phase shifter assembly according to an exemplary example of the present disclosure.

FIG. 5 shows a schematic partial perspective view of the connection between the coaxial cable and the feed line of a base station antenna shown in FIG. 3-FIG. 4.

FIG. 6 shows an enlarged, schematic perspective view of the connection between a feed line in the feed cavity of the base station antenna shown in FIG. 3-FIG. 4 and the transmission line within the phase shifter cavity.

FIG. 7 shows a schematic exploded perspective view of the connection between a feed line in the feed cavity of the base station antenna shown in FIG. 3-FIG. 4 and the transmission line within the phase shifter cavity.

FIG. 8 shows a schematic perspective view of the connection between a radiating element of a base station antenna shown in FIG. 3-FIG. 4 and a first transmission line within the phase shifter cavity.

FIG. 9-FIG. 10 show a base station antenna comprising a plurality of phase shifter assemblies according to an exemplary example of the present disclosure, wherein FIG. 9 is a bottom view of the base station antenna and FIG. 10 is a perspective view of the base station antenna.

FIG. 11 shows a schematic partial perspective view of a base station antenna comprising a phase shifter assembly according to another exemplary example of the present disclosure.

FIG. 12 shows a schematic distribution view of the corresponding line portions within the first cavity, second cavity, third cavity, and fourth cavity of the phase shifter assembly shown in FIG. 11.

FIG. 13 shows a schematic perspective view of one manner of connection between the line portions within the first cavity and second cavity, as well as between the line portions within the third cavity and fourth cavity as shown in FIG. 11.

FIG. 14 shows a schematic partial perspective view of a base station antenna comprising a phase shifter assembly according to another exemplary example of the present disclosure.

FIG. 15-FIG. 16 show schematic distribution diagrams of respective line portions within the first cavity and the second cavity of FIG. 14, respectively.

FIG. 17 shows a schematic perspective view of one manner of connection between the line portions within the first cavity and second cavity as shown in FIG. 14.

FIG. 18 shows a schematic perspective view of another manner of connection between the line portions of the first cavity and the second cavity as shown in FIG. 14.

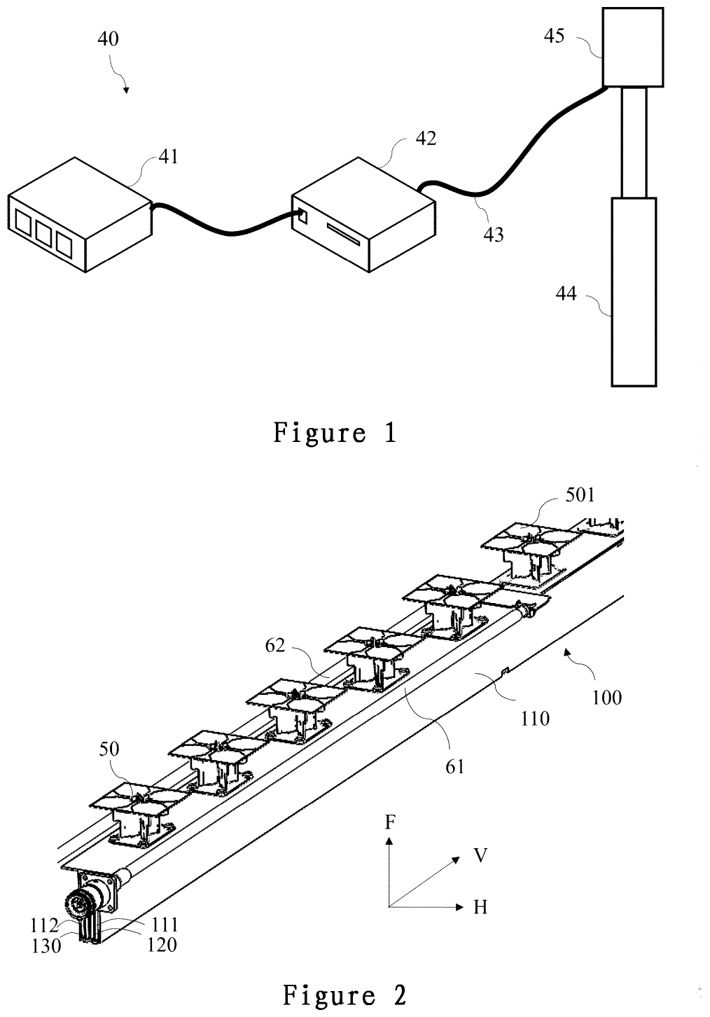

It should be noted that in the embodiments described below, the same reference signs are sometimes used across different attached drawings to denote the same parts or parts with similar functions, and repeated descriptions thereof are omitted. In some cases, similar labels and letters are used to denote similar items. Therefore, once an item is defined in one attached drawing, there is no need for further discussion in subsequent attached drawings.

For ease of understanding, the position, dimension, and range of each structure shown in the attached drawings and the like sometimes do not represent the actual position, dimension, and range. Therefore, the present disclosure is not limited to the positions, dimensions, and ranges disclosed in the attached drawings and the like.

### DETAILED DESCRIPTION

Various exemplary examples of the present disclosure will be described in detail below by referencing the attached drawings. It should be noted that: unless otherwise specifically stated, the relative arrangement, numerical expressions and numerical values of components and steps set forth in these examples do not limit the scope of the present disclosure.

The following description of at least one exemplary example is actually only illustrative, and in no way serves as any limitation to the present disclosure and its application or use. In other words, the structure and method herein are shown in an exemplary manner to illustrate different examples of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those skilled in the art may not be discussed in detail, but where appropriate, the technologies, methods, and equipment should be regarded as part of the Specification.

In all examples shown and discussed herein, any specific value should be construed as merely exemplary value and not as limiting value. Therefore, other examples of the exemplary example may have different values.

The phase shifter assembly according to the various examples of the present disclosure is applicable to various types of base station antennas, such as beamforming antennas or multiple-input multiple-output (MIMO) antennas. These antennas include phase shifters, which adjust the relative phase of sub-components applied to RF signals that may be fed to the radiating elements of the arrays contained in the antenna. The phase shifter and related components in the antenna (such as the cavity used to accommodate the phase shifter) may be constructed as a phase shifter assembly.

It should be understood that the labeled axes in the diagram indicate the vertical or longitudinal direction (V axis), horizontal or transverse direction (H axis), and forward direction (F axis) of the base station antenna 100.

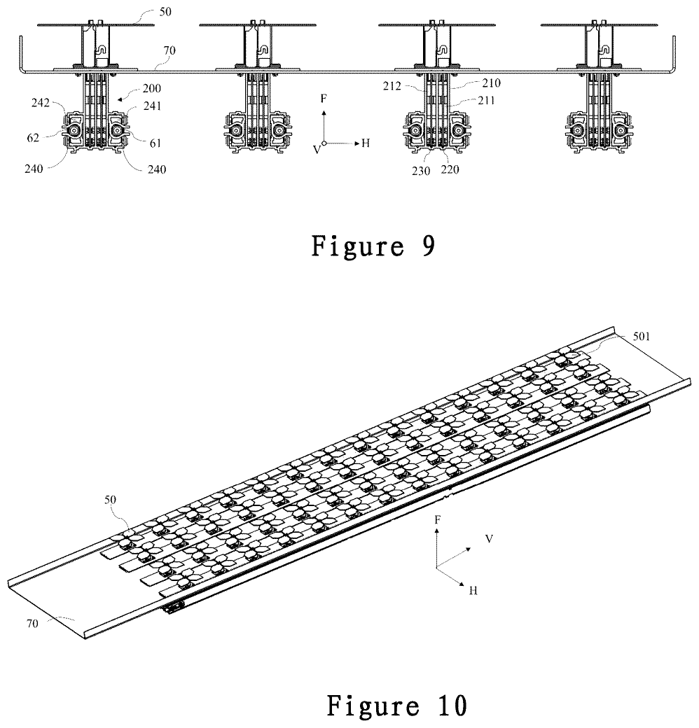

An exemplary base station antenna is described below with reference to FIG. 2. The base station antenna may comprise a phase shifter assembly 100 and an array of radiating elements 50 located on the front side of the phase shifter assembly 100. In some examples, the base station antenna may also comprise a reflector (see, for example, the reflector 70 in FIG. 9 and FIG. 10), with the array of radiating elements 50 located on the front side of the reflector, and the phase shifter assembly 100 may be located on the rear side of the reflector.

The phase shifter assembly 100 may comprise a first housing 110, wherein the first housing 110 may have a first phase shifter cavity 111 and a second phase shifter cavity 112.

A first transmission line 120 may be mounted within the first phase shifter cavity 111 and a second transmission line 130 may be mounted within the second phase shifter cavity 112. It should be understood that the transmission lines herein refer to lines that process RF signals mounted within a phase shifter cavity (e.g., the first phase shifter cavities 111, 211 and the second phase shifter cavities 112, 212) that may, for example, have a line portion for phase shifting, power distribution, and/or phase compensation to achieve phase shifting, power distribution, and/or phase compensation functions.

The base station antenna may also comprise a first coaxial cable 61 and a second coaxial cable 62, wherein the first coaxial cable 61 may feed the first transmission line 120 located inside the first phase shifter cavity 111, and feed the radiating elements 50 with an RF signal in a first polarization direction via the first transmission line 120. The second coaxial cable 62 may feed the second transmission line 130 located inside the second phase shifter cavity 112, and feed the radiating elements 50 with an RF signal in a second polarization direction via the second transmission line 130.

On the one hand, a base station antenna as shown in FIG. 2 generally directly feeds RF signals to the transmission lines located inside phase shifter cavities using coaxial input cables (herein, cables directly feeding RF signals to transmission lines are also referred to as input cables), resulting in significant insertion loss of the antenna, which affects the antenna's gain.

On the other hand, phase shifter cavities generally have a large depth (i.e., the length extending in the forward direction F) to provide sufficient space for arranging the transmission lines. However, larger phase shifter cavities (typically referring to larger phase shifter cavity depths) are prone to causing resonances that can affect the RF performance of antennas, such as when the resonant frequency falls within or near the antenna's operating frequency band. In addition, within a single phase shifter cavity, the transmission line is typically integrated with circuits for phase shifting, power distribution, and/or phase compensation. This leads to a very congested layout of transmission lines inside the phase shifter cavity, resulting in more coupling losses. Furthermore, larger phase shifter cavities take up more space at the back of the base station antenna, which is not conducive to the assembly of other components.

To this end, a phase shifter assembly is provided according to a first aspect of the present disclosure. In the phase shifter assembly according to some examples of the present disclosure, the cable connection input to the phase shifter cavity can at least be eliminated, thereby reducing insertion losses associated with the input cable to the phase shifter cavity and improving the gain performance of the antenna.

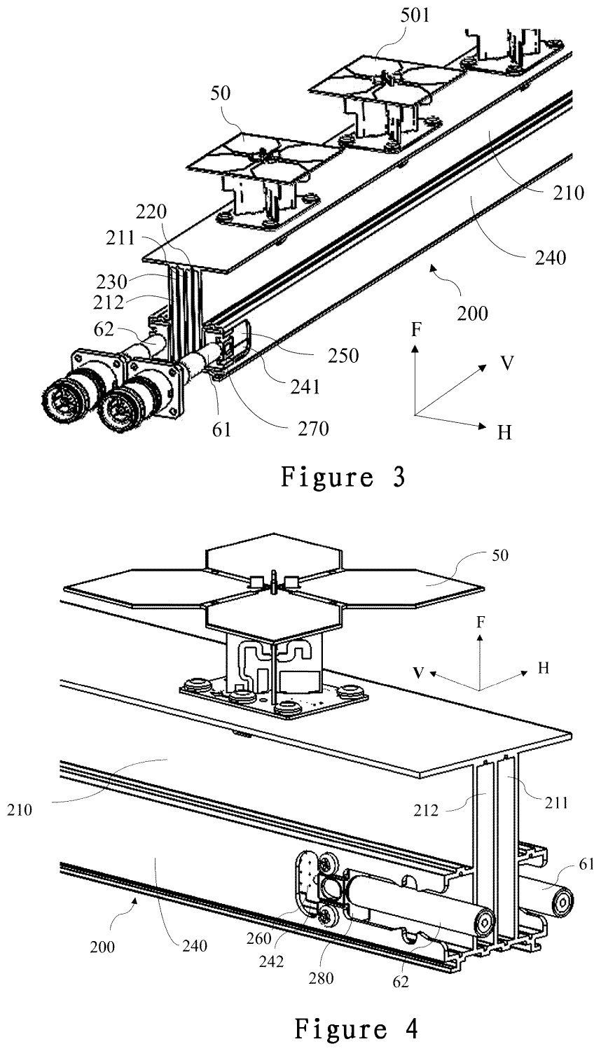

As shown in FIG. 3 and FIG. 4, an exemplary example of the phase shifter assembly 200 according to the present disclosure may comprise a first housing 210 and at least one second housing 240 (as depicted in the figures, there are two second housings 240). Each second housing 240 may be arranged adjacent the first housing 210 in the horizontal direction H. The first housing 210 may comprise a first phase shifter cavity 211 and a second phase shifter cavity 212. A first transmission line 220 may be mounted within the first phase shifter cavity 211 and a second transmission line 220 may be mounted within the second phase shifter cavity 212.

The first second housing 240 may comprise a first feed cavity 241. A first feed line 250 may be mounted within the first feed cavity 241 to feed the first transmission line 220 within the first phase shifter cavity 211. The second housing 240 may comprise a second feed cavity 242. A second feed line 260 may be mounted within the second feed cavity 242 to feed the second transmission line 230 within the second phase shifter cavity 212. In some examples, the first feed line 250 may be configured as a first metal strip line, and/or the second feed line 260 may be configured as a second metal strip line. For example, metal foils or metal sheets can be used as conductors and formed into sheet metal strip lines through processes such as cutting and bending. Alternatively, in some examples, a first printed circuit board may be mounted within the first feed cavity 241 and/or a second printed circuit board may be mounted within the second feed cavity 242, wherein the first feed line 250 may be configured as a first conductive trace printed on the first printed circuit board and/or the second feed line 260 may be configured as a second conductive trace printed on the second printed circuit board.

In order to achieve a transition connection between the first coaxial cable 61 and the first feed line 250, in some examples, the phase shifter assembly 200 according to an exemplary example of the present disclosure may also comprise a first transition component 270. The first transition component 270 may be located at the longitudinal end of the first feed cavity 241. The input portion of the first feed line 250 is generally located proximate this end.

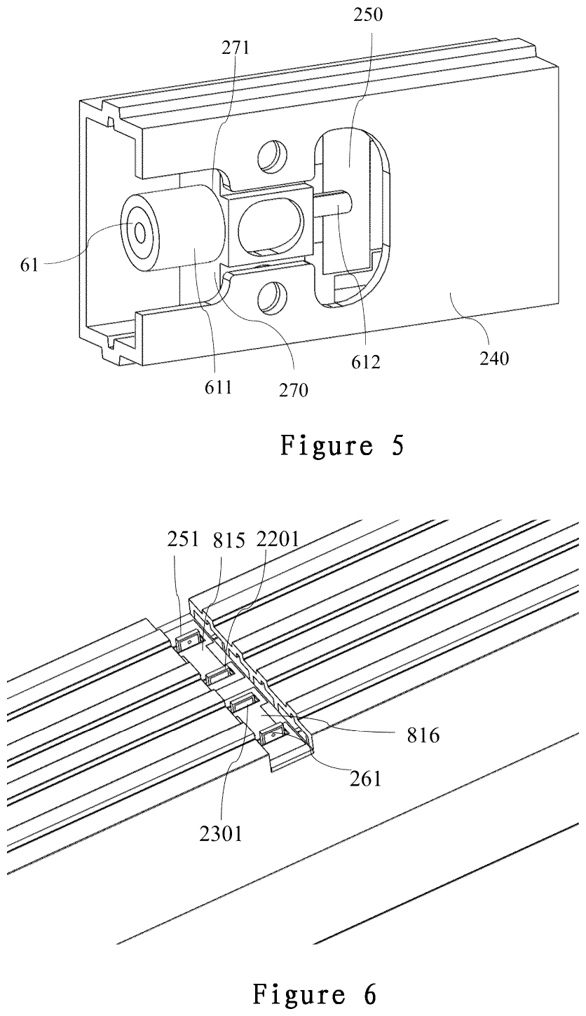

A transitional electrical connection between the first coaxial cable 61 and the first feed line 250 is described in detail below with reference to FIG. 5.

In some examples, the first transition component 270 may be coupled to each second housing 240. Specifically, a coupling gap may be provided between the first transition component 270 and the second housing 240, within which a coupling medium, such as a dielectric spacer, may be placed to achieve an optimized coupling connection between the first transition component 270 and the second housing 240. Additionally, or alternatively, in some examples, the first transition component 270 may be securely connected to the second housing 240 through form-fitting (e.g., press-fitting), force-locking (e.g., threaded connection), and/or material bonding (e.g., soldering, bonding, etc.).

The first transition component 270 may comprise a channel 271 for accommodating the first coaxial cable 61. The first coaxial cable 61 may comprise an outer conductor 611 and an inner conductor 612, wherein the outer conductor 611 may be electrically connected to the first transition component 270 via the inner surface of the channel 271, for example, through contact or coupling connection, in order to ground the outer conductor 611, the first transition component 270, and the second housing 240 together.

The inner conductor 612 may extend into the first feed cavity 241 via the channel 271, thereby being connected to the first feed line 250, for example, through soldering. In a specific example, where the first feed line 250 is the first conductive trace printed on the printed circuit board, soldering may be used to electrically connect the inner conductor 612 to the first feed line 250. In another specific example, where the first feed line 250 is a sheet metal strip line, laser welding can be used to electrically connect the inner conductor 612 to the first feed line 250. A window may be provided in the first feed cavity 241 to provide space for soldering operations between the inner conductor 612 and the first feed line 250. However, the provision of the window may reduce the electrical field continuity within the first feed cavity 241, leading to unstable signal transmission. To compensate for the reduced electrical field continuity, in some embodiments, the first feed line 250 may comprise a first compensation circuit section for capacitive-inductive compensation to improve the standing wave ratio, thereby improving signal transmission efficiency, reducing signal losses, and enhancing the stability of signal transmission.

By feeding the first transmission line 220 through the first feed cavity 211 and the first feed line 250 configured as a strip line inside thereof instead of an input cable, the insertion loss associated with the input cable directly feeding the first transmission line 220 may be reduced, thereby improving the gain performance of the antenna.

In order to achieve a transition connection between the second coaxial cable 62 and the second feed line 260, in some examples, the phase shifter assembly 200 according to an exemplary example of the present disclosure may also comprise a second transition component 280. The second transition component 280 may be located at the longitudinal end of the second feed cavity 242, such as at the bottom end. The input portion of the second feed line 260 is generally located proximate to this end.

For the transitional connection between the second coaxial cable 61 and the second feed line 260, reference may be made to the transitional electrical connection between the first coaxial cable 61 and the first feed line 250 as shown in FIG. 5.

Specifically, the second transition component 280 may be coupled to the second housing 240. The second transition component 280 may comprise a channel for accommodating the second coaxial cable 62. The outer conductor 611 of the second coaxial cable 62 may be electrically connected to the second transition component 280 via the inner surface of the channel, for example, through contact or coupling connection, in order to ground the outer conductor of the second coaxial cable 62, the second transition component 280, and the second housing 240 together. The inner conductor of the second coaxial cable 62 may extend through the channel on the second transition component 280 into the second feed cavity 242, thereby establishing an electrical connection with the second feed line 260.

Some of these specific embodiments may be described with reference to the transitional connection between the first coaxial cable 61 and the first feed line 250 described above, and will not be repeated herein. Wherein, as described above, in order to enhance the standing wave ratio of the second feed line 260 within the second feed cavity 242, and to improve signal transmission efficiency, reduce signal loss, and improve the signal transmission stability, in some examples, the second feed line 260 may comprise a second compensation circuit section for capacitive-inductive compensation.

By feeding the second transmission line 220 through the second feed cavity 242 and the second feed line 260 configured as a strip line inside thereof instead of an input cable, the insertion loss associated with the input cable directly feeding the second transmission line 230 may be reduced, thereby further improving the gain performance of the antenna.

In some examples, each second housing 240 may be integrally molded with the first housing 210, for example, through an extrusion process, such that each second housing 240 and the first housing 210 may be efficiently manufactured without soldering.

In some examples, each second housing 240 and the first housing 210 may be molded separately (e.g., separately molded through an extrusion process). Each second housing 240 may be detachably connected to the first housing 210. In a specific example, each second housing 240 may be secured to the first housing 210 by soldering or laser welding, such that the first housing 210 and each second housing 240 are grounded together.

The detachable connection of each second housing 240 to the first housing 210 may also be advantageous. This detachable connection provides greater flexibility for the placement of the phase shifter assembly 200 in the base station antenna, such as flexibility in adjusting the positions of the second housings 240 in the forward direction relative to the first housing 210 and/or in the longitudinal direction depending on the location of the coaxial cables (e.g., the first coaxial cable 61 and the second coaxial cable 62). In some application scenarios, the rear surface of the first housing 210 and the rear surface of the second housing 240 may be substantially flush in the forward direction. In some application scenarios, the rear surface of the first housing 210 and the rear surface of one or more of the second housings 240 may be staggered in the forward direction. In some application scenarios, the longitudinal end surface (such as the bottom end surface) of each second housing 240 and the longitudinal end surface (such as the bottom end surface) of the first housing 210 may be substantially flush in the longitudinal direction. In some application scenarios, the longitudinal end surface (such as the bottom end surface) of each second housing 240 and the longitudinal end surface (such as the bottom end surface) of the first housing 210 may be staggered in the longitudinal direction.

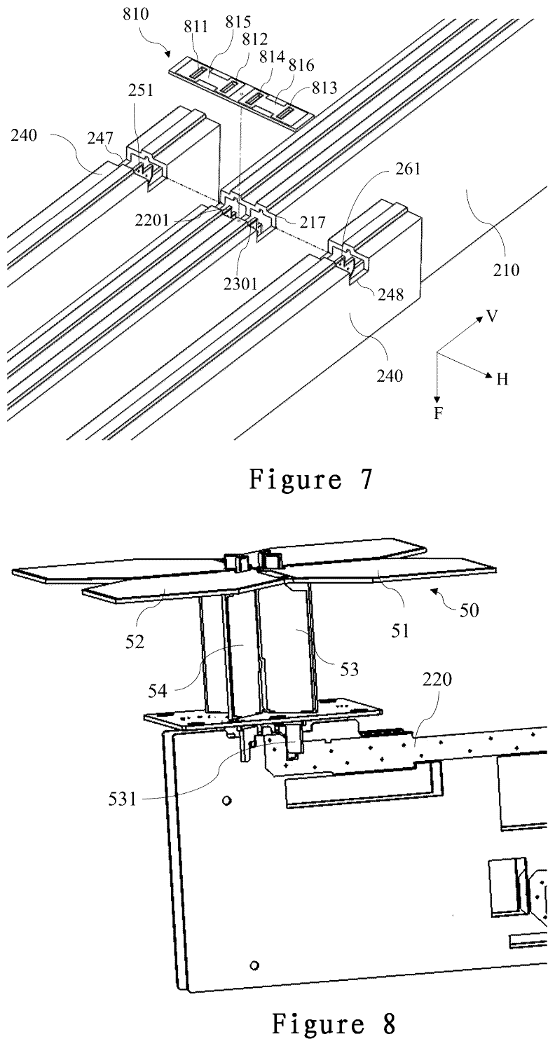

The following describes the connection between the feed line within the feed cavity and the transmission line within the phase shifter cavity with reference to FIG. 6 and FIG. 7.

The first feed line 250 may have a connecting portion 251, while the first transmission line 220 may have a connecting portion 2201, and the connecting portion 251 and the connecting portion 2201 may be electrically connected, for example, via an electrical connection structure 810. This electrical connection structure 810 may be implemented as a conductive structure in a variety of forms, and is not limited to the examples presented in the present disclosure. In some examples, the electrical connection structure 810 may be configured as a PCB component. In some examples, the electrical connection structure 810 may be configured as a probe structure.

In the illustrated example, the electrical connection structure 810 may have an opening 811 for the connecting portion 251, an opening 812 for the connecting portion 2201, and a metal region 815 disposed around the opening 811 and the opening 812. A groove 217 is provided on the rear surface of the first housing 210 and a groove 247 is provided on the rear surface of each second housing 240, with the groove 217 and the groove(s) 247 substantially flush in the horizontal direction, and the electrical connection structure 810 is at least partially housed within the groove 217 and the groove 247.

The connecting portion 251 extends outwardly through the groove 247 and the opening 811 successively, while the connecting portion 2201 extends outwardly through the groove 217 and the opening 812 successively, and the connecting portion 251 may be electrically connected to the connecting portion 2201 via the metal region 815. In some examples, the connecting portion 251 and the connecting portion 2201 may be separately soldered to the metal region 815 to achieve an electrical connection between the first feed line 250 and the first transmission line 220.

The second feed line may have a connecting portion 261, while the second transmission line 230 may have a connecting portion 2301, and the connecting portion 261 and the connecting portion 2301 may be electrically connected via the electrical connection structure 810.

Specifically, the electrical connection structure 810 may also have an opening 813 for the connecting portion 261, an opening 814 for the connecting portion 2301, and a metal region 816 disposed around the opening 813 and the opening 814, wherein the metal region 816 is electrically isolated from the metal region 815. A groove 248 may also be provided on the rear surface of each second housing 240, with the groove 217 and the groove(s) 248 substantially flush in the horizontal direction, and the electrical connection structure 810 may also be at least partially housed within the groove 217 and the groove 247. In some examples, the electrical connection structure 810 may be housed within the region formed by the combination of the groove 217, the groove 247, and the groove 248.

The connecting portion 261 extends outwardly through the groove 248 and the opening 813 successively, while the connecting portion 2301 extends outwardly through the groove 217 and the opening 814 successively, and the connecting portion 261 may be electrically connected to the connecting portion 2301 via the metal region 816. In some examples, the connecting portion 261 and the connecting portion 2301 may be separately soldered to the metal region 816 to achieve the electrical connection between the second feed line 260 and the second transmission line 230.

In some examples, as shown in FIG. 6, the electrical connection between the connecting portion 251 and the connecting portion 2201, as well as the electrical connection between the connecting portion 261 and the connecting portion 2301, may be achieved via an electrical connection structure 810. It should be understood that, in some examples, the electrical connection structure between the connecting portion 251 and the connecting portion 2201 may differ from the electrical connection structure between the connecting portion 261 and the connecting portion 2301, i.e., the opening 811, the opening 812, and the metal region 815, as well as the opening 813, the opening 814, and the metal region 816, may be located on different electrical connection structures.

The electrical connection between the feed line within the feed cavity and the transmission line within the phase shifter cavity is thus achieved. The transmission line may receive RF signals inputted from the feed line. The phase of the corresponding sub-components of the input RF signals may be adjusted via the transmission line within the phase shifter cavity, with each sub-component transmitted to the corresponding radiating element 50 of the radiating element array 501. While FIG. 3 shows only one radiating element array 501, it should be understood that in some examples, there may be a plurality of radiating element arrays 501. For example, FIG. 9 and FIG. 10 schematically show four radiating element arrays. Wherein, the first transmission line 220 may feed the radiating elements 50 with RF signals in a first polarization direction, while the second transmission line 230 may feed the radiating elements 50 with RF signals in a second polarization direction.

Exemplary descriptions will be provided herein in terms of dual-polarized radiating elements, and it should be understood that other types of radiating elements may also be applicable to a phase shifter assembly and base station antenna according to various examples of the present disclosure. Specifically, as shown in FIG. 8, each of the radiating elements 50 may comprise a pair of dipole radiators, wherein one dipole radiator 51 may operate in the first polarization direction (the dipole radiator operating in the first polarization direction will be referred to herein as the first radiator 51) to receive and transmit RF signals in the first polarization direction, and the other dipole radiator 52 may operate in the second polarization direction (the dipole radiator operating in the second polarization direction will be referred to herein as the second radiator 52) to receive and transmit RF signals in the second polarization direction. In one specific example, one dipole radiators may be positioned at an angle of +45° with respect to the longitudinal axis of the base station antenna, and the other dipole radiator may be positioned at an angle of −45° with respect to the longitudinal axis of the base station antenna, such that the dipole radiators are arranged orthogonally to each other. When using dual-polarized radiating elements, in each radiating element array, a first sub-array formed by a plurality of first radiators 51 and a second sub-array formed by a plurality of second radiators 52 may generate decorrelated antenna beams, thereby doubling the number of antenna beams that the base station antenna is capable of generating each time.

The radiating elements 50 may also comprise a first feeder stalk 53 and a second feeder stalk 54, wherein the first radiator 51 is mounted on the first feeder stalk 53, and the second radiator 52 is mounted on the second feeder stalk 54.

The following describes the connection between the transmission line within the phase shifter cavity and the radiating elements with reference to FIG. 8.

FIG. 8 also shows the manner in which the first transmission line 220 is electrically connected to the radiating element 50 to enable transmission of RF signals in the first polarization direction.

In the illustrated example, the first feeder stalk 53 has a conductive portion 531, which can extend into the first phase shifter cavity through an opening (not shown) corresponding to the position of the first phase shifter cavity on the front surface of the first housing 210, to establish an electrical connection with the first transmission line 220. For example, a direct electrical connection between the first feeder stalk 53 and the first transmission line 220 may be achieved by soldering the conductive portion 531 to the first transmission line 220.

In other examples, the first transmission line 220 may have an output portion (not shown), and an opening (not shown) for the output portion to extend forward is provided on the front surface of the first housing 210 at a location corresponding to the first phase shifter cavity. A feed board may also be provided on the front surface of the first housing 210, and the output portion of the first transmission line may extend forward through a corresponding opening of the first housing 210 and be electrically connected to the feeder network on the feed board. Wherein, the first feeder stalk 53 may also be electrically connected to the feeder network on the feed board. Thus, through the feeder network on the feed board, the electrical connection between the first feeder stalk 53 and the first transmission line 220 may be achieved, thereby facilitating the transmission of RF signals in the first polarization direction.

It should be understood that the electrical connection between the second transmission line 230 and the radiating element 50 may be similar to that described above and shown in FIG. 8 to achieve the transmission of RF signals in the second polarization direction, and will not be repeated herein.

FIG. 9 and FIG. 10 show a base station antenna comprising a plurality of phase shifter assemblies 200 according to an exemplary example of the present disclosure, wherein FIG. 9 is a bottom view of the base station antenna and FIG. 10 is a perspective view of the front of the base station antenna.

A plurality of phase shifter assemblies 200 may be positioned on the rear side of the reflector 70 in the forward direction F. In some examples, the reflector 70 may be integrally molded with the first housing 210, allowing the reflector and the first housing 210, for example, to be grounded together without soldering and simplifying the installation process. Alternatively, in some examples, the reflector 70 may be separately formed from the first housing 210, and the reflector 70 may be connected to the first housing 210 through methods such as form-fitting (e.g., press-fitting), force-locking (e.g., threaded connection), and/or material bonding (e.g., soldering, bonding, etc.).

A plurality of radiating elements 50 may be mounted to extend forwardly along the forward direction from the reflector 70. The reflector 70 may be used as the ground plane for the radiating element array 501. The reflector 70 may be constructed of a conductive material such as copper, aluminum, or the like, to suppress radiation from the radiating element array 501. The reflector 70 is capable of redirecting a part of the electromagnetic radiation emitted backward by the radiating elements 50 to propagate forward. It should be understood that in some examples, there may be no reflector 70, but instead, a function similar to that of the reflector 70 may be achieved through the substantially flat front surface of the first housing 210.

The radiating element array may be a high-band radiating element array, mid-band radiating element array, and/or low-band radiating element array. The operating frequency band of the low-band radiating element may be, for example, 617 MHz to 960 MHz or one or more partial ranges thereof. The operating frequency band of the mid-band radiating element may be, for example, 1,427 MHz to 2,690 MHz or one or more partial ranges thereof. The operating frequency band of these high-band radiating elements may be 3 GHz to 5 GHz or one or more partial ranges thereof. Alternatively, radiating element arrays operating in other frequency bands may be provided (e.g., radiating element arrays operating in a portion of the mid-band and in a portion of the high-band).

As will be described in detail below, in some examples, the first phase shifter cavity 211 may comprise a first cavity and a second cavity. The first line portion of the first transmission line 220 may be mounted within the first cavity, and the second line portion of the first transmission line 220 may be mounted within the second cavity, and the first cavity and the second cavity are arranged either side by side in the horizontal direction or perpendicular to each other in the forward direction.

As will be described in detail below, in some examples, the second phase shifter cavity 212 may comprise a third cavity and a fourth cavity, of which, the third line portion of the second transmission line 230 may be mounted within the third cavity, and the fourth line portion of the second transmission line 230 may be mounted within the fourth cavity, and wherein the third cavity and the fourth cavity are arranged either side by side in the horizontal direction or perpendicular to each other in the forward direction.

A phase shifter assembly is provided according to a second aspect of the present disclosure. The phase shifter assembly according to some examples of the present disclosure may at least have phase shifter cavities that have reduced depths, which, on one hand, can reduce the undesirable resonance effects caused by deeper phase shifter cavities and, on the other hand, can improve the spatial utilization of the antenna. In addition, in the phase shifter assembly according to some examples of the present disclosure, more layout space may be provided for the transmission lines inside the phase shifter cavities, thus reducing coupling losses between the lines.

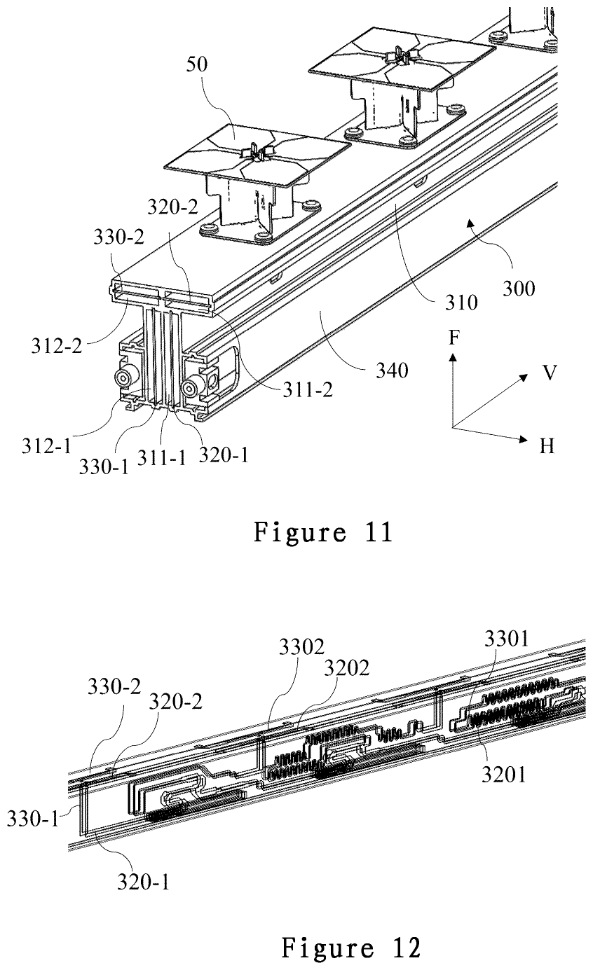

As shown in FIG. 11 and FIG. 14, an exemplary example of a phase shifter assembly 300 according to the present disclosure may comprise a first housing 310.

In some of the examples described above, the first housing 310 generally comprises a first phase shifter cavity and a second phase shifter cavity, wherein the first phase shifter cavity may be mounted with a first transmission line configured to feed RF signals in the first polarization direction to the radiating elements, while the second phase shifter cavity may be mounted with a second transmission line constructed to feed RF signals in the second polarization direction to the radiating elements.

As described above, the transmission lines are typically integrated with circuits for phase shifting, power distribution, and/or phase compensation. This leads to a very congested layout of transmission lines inside the phase shifter cavities, resulting in more coupling losses. Alternatively, in order to provide sufficient space for the arrangement of the transmission lines, it is often necessary to provide deeper phase shifter cavities, which are more prone to resonance and occupy too much space in the antenna for the assembly of the components, which is disadvantageous.

To this end, the first housing 310 may be provided with more than two cavities to split at least one of the first phase shifter cavity and the second phase shifter cavity into a plurality of sub-cavities (e.g., the first cavity 311-1, the second cavity 311-2, the third cavity 312-1, and the fourth cavity 312-2) and to mount the at least one of the first transmission line and the second transmission line in a split manner (e.g., the first line portion 320-1 and the second line portion 320-2 of the first transmission line, as well as the third line portion 330-1 and the fourth line portion 330-2 of the second transmission line) in the plurality of sub-cavities, thereby reducing the depth of at least one of the first phase shifter cavity and the second phase shifter cavity extending in the forward direction, and providing a more flexible arrangement space for the installation of other components in the base station antenna. In addition, more layout space may be provided for at least one of the first transmission line and the second transmission line, thereby reducing the coupling loss between the lines and improving the RF signal transmission efficiency. A first housing having a corresponding number of sub-cavities may be formed as needed (e.g., by an extrusion process) to improve flexibility in the arrangement of the cavities.

Specifically, in some examples, the first housing 310 may comprise a first cavity 311-1 and a second cavity 311-2 for the first transmission line, wherein the first line portion 320-1 of the first transmission line may be mounted within the first cavity 311-1, and the second line portion 320-2 of the first transmission line may be mounted within the second cavity 311-2.

The first transmission line may comprise a first phase shift circuit 3201 and a first power distribution circuit 3202. The first phase shift circuit 3201 may be configured as the first line portion 320-1, or a portion thereof, and the first power distribution circuit 3202 may be configured as the second line portion 320-2, or a portion thereof. As such, the line portions of the first transmission line used for phase shifting and power distribution may be split into two relatively independent cavities, providing more layout space for the first transmission line while maintaining the integrity of the function of the first transmission line. In addition, the first transmission line may further comprise a first phase compensation circuit that may be configured as the first line portion 320-1, or a portion thereof, and/or the second line portion 320-2, or a portion thereof.

Exemplarily, a third printed circuit board may be mounted within the first cavity 311-1 and the first line portion 320-1 may be configured as a third conductive trace printed on the third printed circuit board. A fourth printed circuit board may be mounted within the second cavity 311-2 and the second line portion 320-2 may be configured as a fourth conductive trace printed on the fourth printed circuit board.

In some examples, the first housing 310 may further comprise a third cavity 312-1 and a fourth cavity 312-2 for the second transmission line, wherein the third line portion 330-1 of the second transmission line may be mounted within the third cavity 312-1, and the fourth line portion 330-2 of the second transmission line may be mounted within the fourth cavity 312-2.

The second transmission line may comprise a second phase shift circuit 3301 and a second power distribution circuit 3302. The second phase shift circuit 3301 may be configured as the third line portion 330-1, or a portion thereof, and the second power distribution circuit 3302 may be configured as the fourth line portion 330-2, or a portion thereof. As such, the line portions of the second transmission line used for phase shifting and power distribution may be split into two relatively independent cavities, providing more layout space for the second transmission line while maintaining the integrity of the function of the second transmission line. In addition, the second transmission line may further comprise a second phase compensation circuit that may be configured as the third line portion 330-1, or a portion thereof, and/or the fourth line portion 330-2, or a portion thereof.

Exemplarily, a fifth printed circuit board may be mounted within the third cavity 312-1 and the third line portion 330-1 may be configured as a fifth conductive trace printed on the fifth printed circuit board. A sixth printed circuit board may be mounted within the fourth cavity 312-2 and the fourth line portion 330-2 may be configured as a sixth conductive trace printed on the sixth printed circuit board.

The first line portion 320-1 may have a connecting portion 321, while the second line portion 320-2 may have a connecting portion 322. The connecting portion 321 and the connecting portion 322 may be electrically connected, such that the first line portion 320-1 and the second line portion 320-2 are electrically connected, thereby forming the first transmission line. It should be understood that when the first transmission line is divided into more than two line portions mounted in the corresponding sub-cavities, the connecting portions of each line portion are electrically connected, thereby forming the complete first transmission line to feed RF signals to the radiating elements 50 in the first polarization direction.

In addition, the third line portion 330-1 may have a connecting portion 331, while the fourth line portion 330-2 may have a connecting portion 332, wherein the connecting portion 331 and the connecting portion 332 may be electrically connected, such that the third line portion 330-1 and the fourth line portion 330-2 are electrically connected, thereby forming the second transmission line. It should be understood that when the second transmission line is divided into more than two line portions mounted in the corresponding sub-cavities, the connecting portions of each line portion are electrically connected, thereby forming the complete second transmission line to feed RF signals to the radiating elements 50 in the second polarization direction.

FIG. 11 shows an arrangement of a first cavity 311-1, a second cavity 311-2, a third cavity 312-1, and a fourth cavity 312-2, according to an exemplary example of the present disclosure.

Specifically, the first cavity 311-1 and the second cavity 311-2 may be arranged perpendicular to each other in the forward direction F, wherein the first cavity 311-1 may extend along the forward direction F, while the second cavity 311-2 may extend along the horizontal direction H, and the second cavity 311-2 is positioned in front of the first cavity 311-1 in the forward direction F. The third cavity 312-1 and the fourth cavity 312-2 may be arranged perpendicular to each other in the forward direction F, wherein the third cavity 312-1 may extend along the forward direction F, while the fourth cavity 312-2 may extend along the horizontal direction H, and the fourth cavity 312-2 is positioned in front of the third cavity 312-1 in the forward direction F. As such, the first cavity 311-1 and the second cavity 311-2 may form a “mirrored 7 -or T-shaped” cross-sectional profile, and the third cavity 312-1 and the fourth cavity 312-2 may form a “mirrored 7 -or T-shaped” cross-sectional profile. This “mirrored 7- or T-shaped” cross-sectional profile may advantageously reduce the dimension of the phase shifter assembly in the forward direction. In addition, this “mirrored 7 - or T-shaped” cross-sectional profile may advantageously increase the dimension of the front face of the phase shifter assembly, which can be used to accommodate the feeder stalk of the radiating elements.

Exemplarily, the depth of the first cavity 311-1 and the third cavity 312-1 in the forward direction F may be 35 mm to 47.5 mm.

FIG. 12 shows a schematic distribution of the line portions within each cavity in the arrangement shown in FIG. 11. The first phase shift circuit 3201 may be arranged within the first cavity 311-1 as at least a portion of the first line portion 320-1, the first power distribution circuit 3202 may be arranged within the second cavity 311-2 as at least a portion of the second line portion 320-2, the second phase shift circuit 3301 may be arranged within the third cavity 312-1 as at least a portion of the third line portion 330-1, and the second power distribution circuit 3302 may be arranged within the fourth cavity 312-2 as at least a portion of the fourth line portion 330-2.

In a specific example, RF signals in the first polarization direction may be divided into a plurality of first sub-components via the first power distribution circuit 3202 in order to feed a plurality of first sub-components to the radiating element array 501 (e.g., to feed the first radiator 51 of each radiating element 50 of the radiating element array 501). The first housing 310 may be provided with a plurality of openings at positions on the front surface (corresponding to the second cavity 311-2) for the first feeder stalks of the radiating elements 50 to extend into the second cavity 311-2 and electrically connect to the second line portion 320-2. RF signals in the second polarization direction may be divided into a plurality of second sub-components via the second power distribution circuit 3302 in order to feed a plurality of second sub-components to the radiating element array 501 (e.g., to feed the second radiator 52 of each radiating element 50 of the radiating element array 501). The first housing 310 may be provided with a plurality of openings at position on the front surface (corresponding to the fourth cavity 312-2) for the second feeder stalks of the radiating elements 50 to extend into the fourth cavity 312-2 and electrically connect to the fourth line portion 330-2. The manner in which the first feeder stalks are connected to the second line portion 320-2 and the manner in which the second feeder stalks are connected to the fourth line portion 330-2 may be described with reference to FIG. 8 and the above description based on the phase shifter assembly 200, and will not be repeated herein.

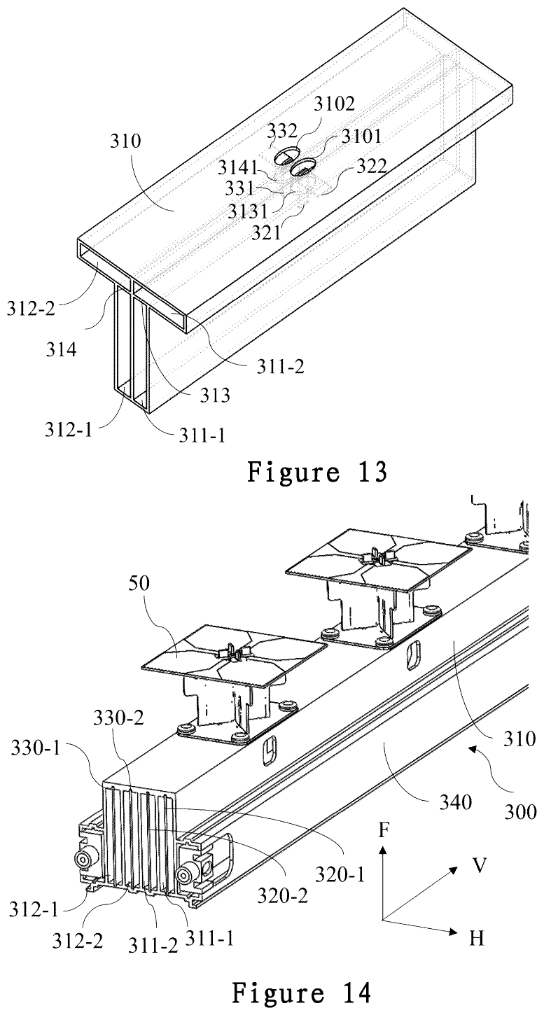

The connection between the first line portion 320-1 and the second line portion 320-2, as well as the connection between the third line portion 330-1 and the fourth line portion 330-2, in the cavity arrangement shown in FIG. 11 is described below with reference to FIG. 13.

Referring to FIG. 13, the connecting portion 321 of the first line portion 320-1 and the connecting portion 322 of the second line portion 320-2 may be arranged substantially perpendicular to each other in the forward direction F. The connecting portion 321 of the first line portion 320-1 may extend along the forward direction F, while the connecting portion 322 of the second line portion 320-2 may extend along the horizontal direction H.

An opening 3131 may be provided in an intermediate plate 313 of the first housing 310 positioned between the first cavity 311-1 and the second cavity 311-2, allowing the connecting portion 321 of the first line portion 320-1 to extend through the opening 3131 into the second cavity 311-2. In some examples, the connecting portion 321 extending into the second cavity 311-2 may be soldered to the connecting portion 322 to achieve the electrical connection between the connecting portion 321 and the connecting portion 322. An access hole 3101 may be provided on the front surface of the first housing 310 to provide space for soldering operations.

The connecting portion 331 of the third line portion 330-1 and the connecting portion 332 of the fourth line portion 330-2 may be arranged substantially perpendicular to each other in the forward direction F. Of this, the connecting portion 331 of the third line portion 330-1 may extend along the forward direction F, while the connecting portion 332 of the fourth line portion 330-2 may extend along the horizontal direction H.

An opening 3131 may be provided in an intermediate plate 314 of the first housing 310 positioned between the third cavity 312-1 and the fourth cavity 312-2, allowing the connecting portion 331 to extend through the opening 3141 into the fourth cavity 312-2. In some examples, the connecting portion 331 extending into the fourth cavity 312-2 may be soldered to the connecting portion 332 to achieve the electrical connection between the connecting portion 331 and the connecting portion 332. An access hole 3102 may be provided on the front surface of the first housing 310 to provide space for soldering operations.

FIG. 14 shows another arrangement of a first cavity 311-1, a second cavity 311-2, a third cavity 312-1, and a fourth cavity 312-2, according to an exemplary example of the present disclosure.

Specifically, the first cavity 311-1 and the second cavity 311-2 may be arranged parallel or side by side to each other in the horizontal direction H, and the first cavity 311-1 and the second cavity 311-2 may separately extend in the forward direction F. The third cavity 312-1 and the fourth cavity 312-2 may be arranged parallel or side by side to each other in the horizontal direction H, and the third cavity 312-1 and the fourth cavity 312-2 may extend in the forward direction F. In the illustrated example, the second cavity 311-2 may be arranged inward relative to the first cavity 311-1, and the fourth cavity 312-2 may be arranged inward relative to the third cavity 312-1, such that the second cavity 311-2 and the fourth cavity 312-2 are adjacent to each other, thereby allowing the first power distribution circuit 3202 and the second power distribution circuit 3302 may be arranged within the adjacent second cavity 311-2 and fourth cavity 312-2, simplifying the feeding connection to the radiation elements 50. In other examples, the various cavities may be arranged in a flexible manner so as to match the design of the radiating elements 50. Exemplarily, the depth of each of the first cavity 311-1, the second cavity 311-2, the third cavity 312-1 and the fourth cavity 312-2 in the forward direction F may be 35 mm to 47.5 mm.

FIG. 12 shows a schematic distribution of the line portions within each cavity in the arrangement shown in FIG. 11.

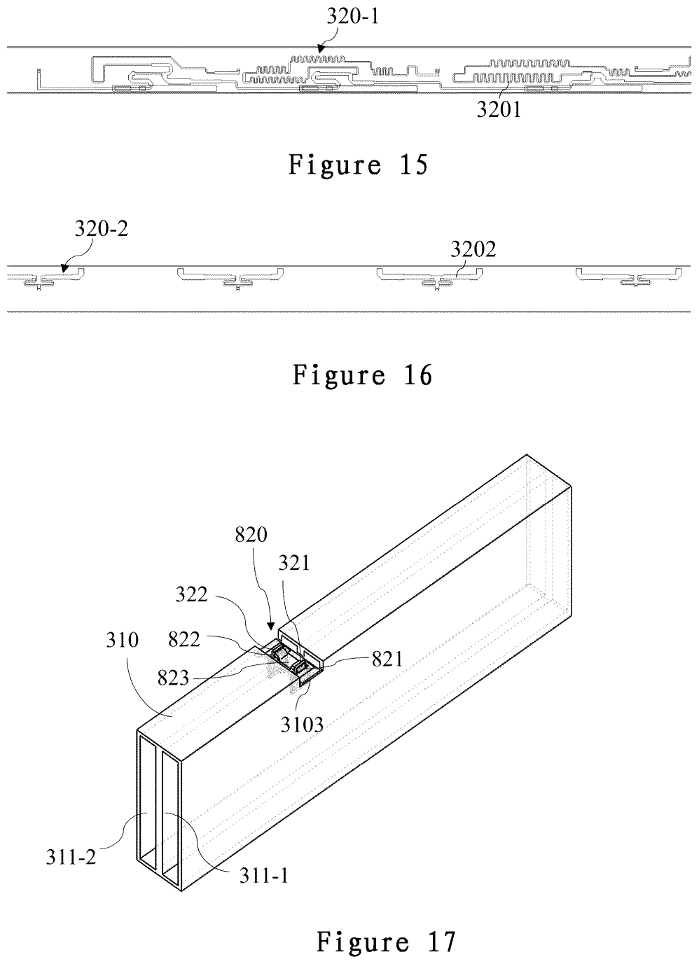

FIG. 15 shows a schematic distribution view of the first line portion 320-1 within the first cavity 311-1 in the arrangement shown in FIG. 14, and FIG. 16 shows a schematic distribution view of the second line portion 320-2 within the second cavity 311-2. The first phase shift circuit 3201 may be configured as the first line portion 320-1, or a portion thereof, and the first power distribution circuit 3202 may be configured as the second line portion 320-2, or a portion thereof. The arrangement of the third line portion 330-1 may be similar to the arrangement of the first line portion 320-1 shown in FIG. 15, and the arrangement of the fourth line portion 330-2 may be similar to the arrangement of the second line portion 320-2 shown in FIG. 16, wherein the second phase shift circuit 3301 may be configured as part of the third line portion 330-1, or a part thereof, within the third cavity 312-1, and the second power distribution circuit 3302 may be configured as part of the fourth line portion 330-2, or a part thereof, within the fourth cavity 312-2.

As described above, the first power distribution circuit 3202 and the second power distribution circuit 3302 may be arranged within the adjacent second cavity 311-2 and fourth cavity 312-2. RF signals in the first polarization direction may be divided into a plurality of first sub-components via the first power distribution circuit 3202. To facilitate feeding a plurality of first sub-components to the radiating element array 501 (e.g., to feed the first radiator 51 of each radiating element 50 of the radiating element array 501), a plurality of openings in the first housing 310 at the front surface of the first housing 310, at a position corresponding to the second cavity 311-2, may be provided for the first feeder stalk of the radiating elements 50 to extend into the second cavity 311-2 and be electrically connected to the second line portion 320-2. RF signals in the second polarization direction may be divided into a plurality of second sub-components via the second power distribution circuit 3302. To facilitate feeding a plurality of second sub-components to the radiating element array 501 (e.g., to feed the second radiator 52 of each radiating element 50 of the radiating element array 501), a plurality of openings in the first housing 310 at the front surface of the first housing 310, at a position corresponding to the fourth cavity 312-2, may be provided for the second feeder stalk of the radiating elements 50 to extend into the second cavity 312-2 and be electrically connected to the fourth line portion 330-2. The manner in which the first feeder stalk is connected to the second line portion 320-2 and the manner in which the second feeder stalk is connected to the fourth line portion 330-2 may be described with reference to FIG. 8 and the above description based on the phase shifter assembly 200, and will not be repeated herein.

The manner of connection between the first line portion 320-1 and the second line portion 320-2 in the cavity arrangement shown in FIG. 14 is described below with reference to FIG. 17.

The connecting portion 321 of the first line portion 320-1 and the connecting portion 322 of the second line portion 320-2 may be electrically connected through an electrical connection structure 820.

Specifically, the electrical connection structure 820 may have an opening 821 for the connecting portion 321, an opening 822 for the connecting portion 322, and a metal region 823 disposed around the opening 821 and the opening 822. A groove 3103 may be provided on the rear surface of the first housing 310, and the electrical connection structure 820 may be at least partially housed within the groove 3103.

Wherein, the connecting portion 321 extends outwardly through the groove 3103 and the opening 821 successively, while the connecting portion 322 extends outwardly through the groove 3103 and the opening 822 successively, and the connecting portion 321 may be electrically connected to the connecting portion 322 via the metal region 823. In some examples, the connecting portion 321 and the connecting portion 322 may be separately soldered to the metal region 823 to achieve the electrical connection between the first line portion 320-1 and the second line portion 320-2.

It should be understood that the manner of connection between the third line portion 330-1 and the fourth line portion 330-2 in the cavity arrangement shown in FIG. 14 may be described with reference to the manner of connection between the first line portion 320-1 and the second line portion 320-2, in the cavity arrangement shown in FIG. 17, and will not be repeated herein.

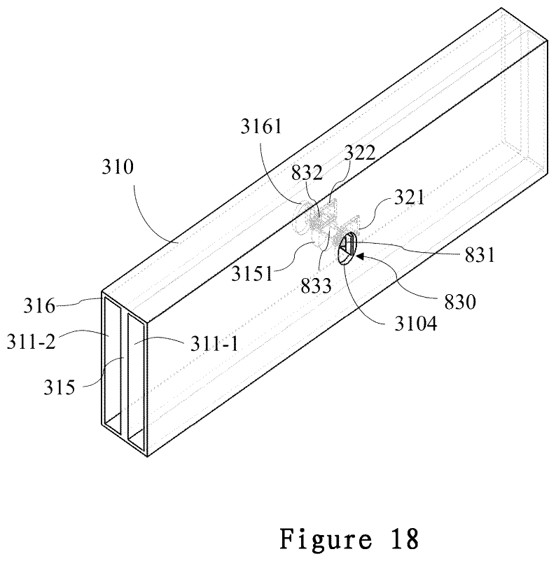

Another manner of connection between the first line portion 320-1 and the second line portion 320-2 in the cavity arrangement shown in FIG. 14 is described below with reference to FIG. 18.

The connecting portion 321 of the first line portion 320-1 and the connecting portion 322 of the second line portion 320-2 may be electrically connected through an electrical connection structure 830.

An opening 3151 may be provided in an intermediate plate 315 of the first housing 310 positioned between the first cavity 311-1 and the second cavity 311-2. The electrical connection structure 830 may be spanned between the first cavity 311-1 and the second cavity 311-2 via the opening 3151, for example, in the horizontal direction, wherein the first portion of the electrical connection structure 830 may be located inside the first cavity 311-1, and the second portion of the electrical connection structure 830 may be located inside the second cavity 311-2.

The connecting portion 321 and the connecting portion 322 may be separately connected to the electrical connection structure 830, and the electrical connection between the connecting portion 321 and the connecting portion 322 may be achieved via the electrical connection structure 830. In some examples, the connecting portion 321 and the connecting portion 322 may separately extend to the metal region of the electrical connection structure 830, and the electrical connection between the connecting portion 321 and the connecting portion 322 may be achieved via the metal region of the electrical connection structure 830. Alternatively, in some other examples, with reference to FIG. 18, the electrical connection structure 830 may have an opening 831 for the connecting portion 321, an opening 832 for the connecting portion 322, and a metal region 823 [sic: 833] disposed around the opening 831 and the opening 832. Of these, the opening 831 is located in the first portion of the electrical connection structure 830 and the opening 832 is located in the second portion of the electrical connection structure 830. The connecting portion 321 may extend to the opening 831 and the connecting portion 322 may extend to the opening 832. The connecting portion 321 may be electrically connected to the connecting portion 322 via the metal region 833. In a specific example, the connecting portion 321 and the connecting portion 322 may be separately soldered to the metal region 833 to achieve the electrical connection between the first line portion 320-1 and the second line portion 320-2. An access hole 3104 may be provided on the longitudinal end surface of the first housing to provide space for soldering the connecting portion 321 to the metal region 833, and an access hole 3161 may be provided on an intermediate plate 316 between the second cavity 311-2 and the fourth cavity 312-2 to provide space for soldering the connecting portion 322 to the metal region 833.

It should be understood that another manner of connection between the third line portion 330-1 and the fourth line portion 330-2 in the cavity arrangement shown in FIG. 14 may be described with reference to another manner of connection between the first line portion 320-1 and the second line portion 320-2, in the cavity arrangement shown in FIG. 18, and will not be repeated herein.

In some examples, RF signals may be directly fed from the input coaxial cable to the first line portion 320-1 and/or the third line portion 330-1. Alternatively, in some examples, as shown in FIG. 11 and FIG. 14, RF signals may be fed through the power feed cavity of the second housing 340 and the feed line mounted therein instead of the input cable to the first line portion 320-1 and/or the third line portion 330-1. Of these, the transition connection of the first line portion 320-1 and/or the third line portion 330-1 with the feed line at the input end, as well as descriptions that may be provided based on the phase shifter assembly 200 in the preceding text, will not be repeated herein.

According to a third aspect of the present disclosure, a base station antenna is also provided. With reference to FIG. 3-FIG. 4, FIG. 9-FIG. 10, FIG. 11 and FIG. 14, an exemplary base station antenna according to the present disclosure may comprise a plurality of the phase shifter assemblies described above (e.g., the phase shifter assembly 200 or the phase shifter assembly 300). In addition, an exemplary base station antenna according to the present disclosure may also comprise at least one of an array of radiating elements 50, a reflector 70, and coaxial cables (e.g., coaxial cable 61 and coaxial cable 62). Of these, some examples may be described with reference to the phase shifter assembly 200 and/or the phase shifter assembly 300 described above, and will not be repeated herein.

The terms “left”, “right”, “front”, “rear”, “top”, “bottom”, “upper”, “lower”, “high”, “low” herein, if present, are used for descriptive purposes and not necessarily used to describe constant relative positions. It should be understood that the terms used in this way are interchangeable under appropriate circumstances, so that the examples of the present disclosure described herein, for example, can operate on other orientations that differ from those orientations shown herein or otherwise described. For example, when the device in the attached drawings is turned upside down, features that were originally described as “above” other features can now be described as “below” other features. The device may also be oriented by other means (rotated by 90 degrees or at other locations), in which case the relative spatial relationships will be explained accordingly.

Herein, when an element is referred to as being “above” another element, “attached” to another element, “connected” to another element, “coupled” to another element, or “in contact with” another element, the element may be directly above another element, directly attached to another element, directly connected to another element, directly coupled to another element, or directly in contact with another element, or there may be one or a plurality of intermediate elements. In contrast, if an element is described as “directly” “above” another element, “directly attached” to another element, “directly connected” to another element, “directly coupled” to another element or “directly in contact with” another element, there will be no intermediate elements. In the Specification and Claims, a feature that is arranged “adjacent” to another feature may denote that a feature has a part that overlaps an adjacent feature or a part located above or below the adjacent feature.

As used herein, the word “exemplary” means “serving as an example, instance, or illustration” rather than as a “model” to be copied exactly. Any implementation method described exemplarily herein may not be necessarily interpreted as being preferable or advantageous over other implementation methods. Moreover, the present disclosure is not limited by any expressed or implied theory given in the technical field, background art, summary of the invention, or specific embodiments.

As used herein, the word “substantially” means comprising any minor changes caused by design or manufacturing defects, device or component tolerances, environmental influences, and/or other factors. The word “substantially” also allows for differences from the perfect or ideal situation due to parasitic effects, noise, and other practical considerations that may be present in the actual implementation.

In addition, for reference purposes only, “first”, “second” and similar terms may also be used herein, and thus are not intended to be limiting. For example, unless clearly indicated by the context, the words “first”, “second” and other such numerical words involving structures or elements do not imply a sequence or order.

It should also be understood that when the term “include/comprise” is used herein, it indicates the presence of the specified feature, entirety, step, operation, unit and/or component, but does not exclude the presence or addition of one or more other features, entireties, steps, operations, units and/or components and/or combinations thereof.

In the present disclosure, the term “provide” is used in a broad sense to cover all manners of obtaining an object, so “providing an object” includes but is not limited to “purchase”, “preparation/manufacturing”, “arrangement/setting”, “mounting/assembly”, and/or “ordering” of the object, etc.

As used herein, the term “and/or” includes any and all combinations of one or more of the associated listed items. The terms used herein are only for the purpose of describing specific examples, and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed among additional operations, and the operations can be executed at least partially overlapping in time. Also, alternative examples may include a plurality of instances of specific operations, and the order of operations may be changed in various other examples. However, other modifications, changes and substitutions are also possible. Aspects and elements of all examples disclosed above may be combined in any manner and/or in conjunction with aspects or elements of other examples to provide a plurality of additional examples. Therefore, the Specification and attached drawings hereof should be regarded as illustrative rather than limiting.

Although some specific examples of the present disclosure have been described in detail through examples, those skilled in the art should understand that the above examples are only for illustration rather than for limiting the scope of the present disclosure. The examples disclosed herein can be combined arbitrarily without departing from the spirit and scope of the present disclosure. Those skilled in the art should also understand that various modifications may be made to the examples without departing from the scope and spirit of the present disclosure. The scope of the present disclosure is defined by the attached claims.

1. A phase shifter assembly, comprising:
a first housing comprising a first cavity and a second cavity, wherein the first cavity and the second cavity are arranged either side by side in the horizontal direction or perpendicular to each other in the forward direction; and
a first transmission line configured to feed radiating elements with an RF signal in a first polarization direction, wherein a first line portion of the first transmission line is mounted within the first cavity and a second line portion of the first transmission line is mounted within the second cavity.

2. The phase shifter assembly according to claim 1, wherein the first line portion of the first transmission line comprises a first phase shift circuit and the second line portion of the first transmission line comprises a first power distribution circuit.

3. The phase shifter assembly according to claim 1, wherein the first line portion has a first connecting portion and the second line portion has a second connecting portion, wherein the first connecting portion and the second connecting portion are electrically connected.

4. The phase shifter assembly according to claim 3, wherein the first line portion is electrically connected to the second connecting portion via a first electrical connection structure, wherein the first electrical connection structure has a first opening for the first connecting portion, a second opening for the second connecting portion and a first metal region disposed around the first opening and the second opening.

5. The phase shifter assembly according to claim 4, wherein when the first cavity and the second cavity are arranged side by side in the horizontal direction:
a first groove is provided on the rear surface of the first housing, with the first electrical connection structure accommodated within the first groove, wherein the first connecting portion extends outwardly through the first groove and the first opening successively, and the second connecting portion extends outwardly through the first groove and the second opening successively; and/or
a third opening is provided on a first intermediate plate located between the first cavity and the second cavity, with the first electrical connection structure spanned between the first cavity and the second cavity via the third opening, wherein the first connecting portion extends to the first opening of the first electrical connection structure and the second connecting portion extends to the second opening of the first electrical connection structure.

6. The phase shifter assembly according to claim 3, wherein when the first cavity and the second cavity are arranged perpendicular to each other in the forward direction, a fourth opening is provided on the second intermediate plate located between the first cavity and the second cavity, and the first connecting portion is capable of extending into the second cavity along the forward direction through the fourth opening so as to be electrically connected to the second connecting portion within the second cavity.

7. The phase shifter assembly according to claim 1, wherein the first housing further comprises:
a third cavity and a fourth cavity, wherein the third cavity and the fourth cavity are arranged either side by side in the horizontal direction or perpendicular to each other in the forward direction; and
the phase shifter assembly further comprises:
a second transmission line configured to feed radiating elements with an RF signal in a second polarization direction, wherein a third line portion of the second transmission line is mounted within the third cavity and a fourth line portion of the second transmission line is mounted within the fourth cavity.

8. (canceled)

9. The phase shifter assembly according to claim 7, wherein the third line portion has a third connecting portion and the fourth line portion has a fourth connecting portion, wherein the third connecting portion and the fourth connecting portion are electrically connected.

10. The phase shifter assembly according to claim 9, wherein the third line portion is electrically connected to the fourth connecting portion via a second electrical connection structure, wherein the second electrical connection structure has a fifth opening for the third connecting portion, a sixth opening for the fourth connecting portion and a second metal region disposed around the sixth opening and the fifth opening.

11. The phase shifter assembly according to claim 10, wherein when the third cavity and the fourth cavity are arranged side by side in the horizontal direction:
a second groove is provided on the rear surface of the first housing, with the second electrical connection structure accommodated within the second groove, wherein the third connecting portion extends outwardly through the second groove and the fifth opening successively, and the fourth connecting portion extends outwardly through the second groove and the sixth opening successively; and/or
a seventh opening is provided on a third intermediate plate located between the third cavity and the fourth cavity, with the second electrical connection structure spanned between the third cavity and the fourth cavity via the seventh opening, wherein the third connecting portion extends to the fifth opening of the second electrical connection structure and the fourth connecting portion extends to the sixth opening of the second electrical connection structure.

12. (canceled)

13. The phase shifter assembly according to claim 7, wherein
when the first cavity and the second cavity are arranged perpendicular to each other in the forward direction, the first cavity extends in the forward direction, and the second cavity extends in the horizontal direction and is positioned in front of the first cavity in the forward direction; and
when the third cavity and the fourth cavity are arranged perpendicular to each other in the forward direction, the third cavity extends in the forward direction, and the fourth cavity extends in the horizontal direction and is positioned in front of the third cavity in the forward direction.

14. (canceled)

15. The phase shifter assembly according to claim 7, wherein the first cavity and the second cavity are arranged side by side with each other in the horizontal direction, the third cavity and the fourth cavity are arranged side by side with each other in the horizontal direction, the second cavity is positioned inward relative to the first cavity, and the fourth cavity is positioned inward relative to the third cavity, such that the second cavity and the fourth cavity are adjacent to each other.

16-22. (canceled)

23. A phase shifter assembly, wherein the phase shifter assembly comprises:
a first housing comprising a first phase shifter cavity;
a first transmission line mounted within a first phase shifter cavity;
a second housing arranged adjacent to the first housing in the horizontal direction, wherein the second housing and the first housing may be detachably connected, wherein the second housing comprises a first feed cavity; and
a first feed line mounted within the first feed cavity, wherein the first feed line is configured to feed the first transmission line.

24. (canceled)

25. The phase shifter assembly according to claim 23, wherein
the first feed line is configured as a first metal strip line; or
the first feed line is configured as a first conductive trace printed on a first printed circuit board.

26. The phase shifter assembly according to claim 23, wherein the phase shifter assembly further comprises:
a first transition component for a first coaxial cable located at the longitudinal end of the first feed cavity.

27. The phase shifter assembly according to claim 26, wherein the first transition component is coupled to the second housing.

28. The phase shifter assembly according to claim 26, wherein the first transition component has a first channel for accommodating the first coaxial cable, wherein an inside surface of the first channel is configured to electrically connect with an outer conductor of the first coaxial cable, and the first channel is configured to allow an inner conductor of the first coaxial cable to extend into the first feed cavity via the first channel.

29. The phase shifter assembly according to claim 28, wherein an access hole is provided on the first feed cavity to provide a soldering space for the connection between the inner conductor of the first coaxial cable and the first feed line, wherein the first feed line comprises a first compensation circuit section for capacitive-inductive compensation.

30. The phase shifter assembly according to claim 23, wherein the first phase shifter cavity comprises a first cavity and a second cavity, the first line portion of the first transmission line is mounted within the first cavity and the second line portion of the first transmission line is mounted within the second cavity, wherein the first cavity and the second cavity are arranged side by side in the horizontal direction or arranged perpendicular to each other in the forward direction.

31. The phase shifter assembly according to claim 23, wherein the first housing further comprises a second phase shifter cavity, the second housing further comprises a second feed cavity, and the phase shifter assembly further comprises:
a second transmission line mounted within the second phase shifter cavity; and
a second feed line mounted within the second feed cavity, wherein the second feed line is configured to feed the second transmission line.

32-42. (canceled)
